(19) United States
(12) Patent Application Publication
(10) Pub. No.: US 2024/0234834 A1
(43) Pub. Date: Jul. 11, 2024

(54) GLASSY CARBON COATINGS

(71) Applicant: DayLyte, Inc., Knoxville, TN (US)

(72) Inventor: Caleb Tyler Alexander, Knoxville, TN (US)

(21) Appl. No.: 18/406,134

(22) Filed: Jan. 6, 2024

Related U.S. Application Data
(60) Provisional application No. 63/458,696, filed on Apr. 12, 2023.
(60) Provisional application No. 63/437,637, filed on Jan. 6, 2023.

(51) Int. Cl. H01M 10/42; H01M 4/04; H01M 4/24; H01M 4/66; H01M 12/08

(52) U.S. Cl. CPC H01M 10/4235; H01M 4/0404; H01M 4/24; H01M 4/663; H01M 4/667; H01M 12/08

(57) ABSTRACT

Glassy carbon coatings exhibiting high thermal stability, high electrical and thermal conductivity, low friction, impermeability, and extreme resistance to chemical attack are disclosed. The glassy carbon coatings are formed from carbonization of a phenolic resin or non-graphitizable polymer. An optional thermal shock resistant substrate can be included. Methods of making and using the glassy carbon coatings are further disclosed. The glassy carbon coatings are particularly useful for inclusion in metal air batteries.

### STATEMENT REGARDING FEDERALLY-SPONSORED RESEARCH

This invention was made with government support under Small Business Technology Transfer Grant Award DE-SC0022492 awarded by the U.S. Dept. of Energy. The government has certain rights in the invention.

### CROSS-REFERENCE TO RELATED APPLICATIONS

The present application claims the priority benefit of U.S. Provisional Patent App. Ser. No. 63/437,637, filed Jan. 6, 2023, titled “Smooth, Chemically Resistant Carbon Coatings”; and of U.S. Provisional Patent App. Ser. No. 63/458,696, filed Apr. 12, 2023, titled “Thermal Shock Resistant Foils”, each of which is hereby incorporated by reference herein in their respective entireties.

### TECHNICAL FIELD

The present disclosure relates generally to glassy carbon coatings as well as to devices, such as metal air batteries, which comprise such coatings.

### BACKGROUND

Functional coatings are an essential component of many substrates that influence, or even determine, the final properties exhibited by the substrate. For example, functional coatings can modify, or provide, numerous properties to a substrate including durability, chemical resistance, chemical compatibility, thermal resistance, surface smoothness, wettability, and electrical conductivity. Known functional coatings, however, must balance compatibility with particular substrates as well as the particular properties that can be conveyed to the substrate. It would be desirable to provide improved functional coatings which could offer higher compatibility with various substrates while also providing an improved combination of properties.

### BRIEF DESCRIPTION OF THE DRAWINGS

FIG. 1 depicts a side-view of an exemplary metal air battery which the glassy carbon coatings can be useful to improve the performance of.

FIG. 2 depicts a photograph showing a sample of a glassy carbon coating.

FIGS. 3 and 4 respectively depict Raman and x-ray crystallography (“XRD”) spectra of an example glassy carbon coating.

FIG. 5 depicts surface roughness measurements of an additional glassy carbon coating sample.

FIGS. 6A to 6F depict scanning electron microscope images of the additional glassy carbon coating sample.

### DETAILED DESCRIPTION

Glassy carbon coatings having wide compatibility with various substrates and which exhibit numerous benefits will be described herein. In particular, the glassy carbon coatings described herein can provide extremely smooth surfaces with improved durability and chemical compatibility. Methods of making and using the glassy carbon coatings are further described.

As used herein, glassy carbon (also known as ‘hard carbon’) refers to an amorphous form of carbon possibly with graphite nanodomains that exhibits both glassy ceramic properties, such as durability and chemical resistance properties, with the electrical and thermal properties of graphite. Generally glassy carbon has high thermal stability, high electrical and thermal conductivity, low friction, impermeability, and extreme resistance to chemical attack. However, known bulk glassy carbon exhibits a hardness of 7 Mohs and is not flexible.

It has presently been discovered that thin coatings of glassy carbon can be formed on a substrate. The thinness of the presently discovered glassy carbon coatings enables the coatings to be flexible while still offering desirable properties of glassy carbon including high thermal stability, high electrical and thermal conductivity, low friction, impermeability, and extreme resistance to chemical attack. Additionally, the presently discovered glassy carbon coatings form extremely smooth surfaces that remove surface roughness from the underlying substrate. The coatings can be formed in-situ on various substrates or be formed independently and then applied as a tape-like material.

As can be appreciated, the properties of the glassy carbon coatings described herein can make the coatings suitable for a variety of purposes. For example, the described coatings can be used to form coatings for sensors; electrodes; medical devices including surgical instruments, surgical implants, and dental implants; cookware; and as a protective lining for potentially dangerous chemicals. The coatings can be applied in-situ to form a coating on an already formed product or be applied as a tape-like coating to a substrate. In certain embodiments, it can be advantageous to form the glassy carbon coating in-situ to provide excellent contact between the underlying substrate and the glassy carbon coating without the use of adhesives or other binders.

In certain embodiments, the glassy carbon coatings described herein can be formed by depositing one or more layers of phenolic resin or other non-graphitizable polymers on a substrate, allowing surface tension of the resin or polymer to form a flat surface, and then using heat to set and carbonize the resin or polymer to form a glassy carbon.

As can be appreciated, many variations to this process are possible. For example, in certain embodiments, glassy carbon in addition, or as an alternative to phenolic resin or other non-graphitizable polymer, can be applied to a substrate. Suitable deposition techniques include chemical processes such as various chemical vapor deposition processes, and vacuum deposition processes including physical vapor deposition, electron-beam deposition, sputter deposition, as well as ambient methods like solution deposition. Examples of suitable solution deposition techniques that are suited for deposition of the phenolic resin or other non-graphitizable polymer include spin coating, dip coating, inkjet printing, aerosol jet, slot die coating, gravure coating, flexographic printing, Mayer rod coating, and spray coating processes. In certain embodiments, a spray coating can be particularly advantageous as such processes are well known, easily adjustable, and provide a coating of sufficient thickness to allow the surface tension of the phenolic resin or non-graphitizable polymer to form an extremely smooth surface. Suitable phenolic resins and non-graphitizable polymers include polymers which can be carbonized. A wide variety of phenolic resins and non-graphitizable polymers can be suitable as the resin or polymer will be carbonized during the formation of the glassy carbon coating volatilizing substantially most of the non-carbon atoms present in the resin or polymer. Suitable phenolic resins are generally formed by the reaction of phenol with formaldehyde. Various ratios of phenol and formaldehyde can be used to vary the properties of the phenolic resin. The amenability of the present process to use various phenolic resins facilitates ease of handling and manufacturing by enabling a phenolic resin to be selected having a desired viscosity and tackiness. Similarly, other non-graphitizable polymers can be selected based on their properties in the liquid form.

In certain embodiments, various additives can be included in the phenolic resin or other non-graphitizable polymer, or applied on the substrate, to simplify application or handling. For example, one or more plasticizers or surfactants can be included to help conform the phenolic resin to the substrate being coated. Additionally, or alternatively, in certain embodiments, a crosslinking agent can be used to crosslink and set the phenolic resin on the substrate before carbonization. However, in other embodiments, the phenolic resin or other non-graphitizable polymer can be used without any additives to ensure a uniform glassy carbon coating is formed without any voids or other defects caused by volatilization of additives.

In certain embodiments where additional bonding strength between the substrate and the glassy carbon coating is required, an interlayer material can be formed or applied to the substrate before application or formation of the glassy carbon. Generally, such interlayers can be formed of materials that can form chemical bonds to both the substrate and the glassy carbon coating. For metal substrates, carbides can be particularly advantageous interlayer materials as they can become chemically incorporated with both the substrate and the glassy carbon layer. In such embodiments, the carbides can be formed of either the same metal as the substrate or a metal that can alloy with the metal of the metal substrate. For example, for steel substrates, iron carbides or nickel carbides can form a very strong bonding layer that bonds with both the substrate and the glassy carbon layer. Other suitable materials for the interlayer material include aluminum, silicon, titanium, germanium, cobalt, nickel, chromium, iron and tantalum and their respective carbides. These materials and their carbides can be formed through known carburizing processes or through various deposition processes such as chemical vapor deposition, physical vapor deposition, sputtering, etc. Interlayer materials can be particularly advantageous for copper substrates which exhibit less inherent adhesion to glassy carbon layers.

Additionally, or alternatively, additional bonding strength can be provided through physical modification of the substrate to provide additional surface area. Such physical modification can be performed mechanically (e.g., through sanding, scuffing, or other ablative processes) chemically (e.g., through etching, selective dissolution, etc.) or energetically (laser ablation, e-beam treatments, ozone treatments, etc.).

In certain embodiments, once phenolic resin or other non-graphitizable polymer is applied to a substrate and allowed to form a smooth surface through surface tension, the phenolic resin or other non-graphitizable polymer can be set. In such embodiments, the phenolic resin or other non-graphitizable polymer can be set through any suitable mechanism. For example, in certain embodiments, heat can be used to set the phenolic resin or other non-graphitizable polymer while in other embodiments, UV light or an e-beam can be used. Once set, the phenolic resin or other non-graphitizable polymer can be carbonized in the absence of oxygen. Alternatively, in certain embodiments, the step of setting the phenolic resin or other non-graphitizable polymer can be omitted or be performed simultaneously with the carbonization process.

Carbonization of the phenolic resin or other non-graphitizable polymer can occur at elevated temperatures in either air or vacuum. Suitable temperatures for the carbonization of phenolic resin or other non-graphitizable polymer include temperatures of about 800° C. to about 3000° C. It can be useful to carbonize in an inert gas such as nitrogen, argon, hydrogen or their mixtures to prevent ignition of the phenolic resin or other non-graphitizable polymer or glassy carbon. Temperatures of about 500 to about 800° C. can be used to begin the carbonization process, but the material will be highly resistive. In certain embodiments, a xenon flash lamp or laser can be used to heat the resin or polymer but any suitable heating source can work.

Generally, each layer of phenolic resin or other non-graphitizable polymer can be applied in a thickness of about 0.05 microns to about 50 microns and then carbonized to form a glassy carbon having a thickness of about 0.025 microns to about 25 microns. In certain embodiments, the number of layers of glassy carbon can vary from 1 to about 100 layers. In certain embodiments, the durability of the glassy carbon layers can enable extremely durable glassy carbon coating layers formed of only a few, or even just one, glassy carbon layer, but a sufficiently thick glassy carbon layer (either as a single layer or as multiple layers) will be needed to completely coat the surface roughness of the underlying substrate for applications that require a complete glassy carbon coating. If multiple layers are included, each successive coating layer can decrease surface roughness for applications requiring extremely smooth surfaces.

### Thermal Shock Resistant Substrate

In certain embodiments, it can be useful to further provide a thermal shock resistant substrate to support the glassy carbon coatings described herein. The thermal shock resistant substrate can prevent cracks, warping or other defects from propagating through the coating layer due to thermal expansion and contraction during heating with large thermal gradients like with lasers, xenon flash lamps or other asymmetric heating methods. For example, in certain embodiments, a glassy carbon coating layer can be formed on a thermal shock resistant substrate. Generally, the thermal shock resistant substrate can be formed of any material that has a low coefficient of thermal expansion such as certain metals and ceramic materials or is a single crystal.

As can be appreciated, the glassy carbon layer can be formed on top of the thermal shock resistant substrate. For example, a phenolic resin can be applied to the substrate followed by heating in the absence of oxygen to form a completed glassy carbon coating layer on top of a thermal shock resistant substrate. In other embodiments, each glassy carbon coating layer can be formed before application of a thermal bonding layer.

Suitable materials for the thermal shock resistant substrates can include any materials with a low Young's Modulus and/or low coefficient of thermal expansion. In certain embodiments, such materials include materials having a coefficient of thermal expansion of about 0 to about 15 μm/(m*K) such as materials having a coefficient of thermal expansion of about 0 to about 7 μm/(m*K). Exemplary materials having such coefficients of thermal expansion include crystalline metals such as copper, zirconium, hafnium, chromium, germanium, tantalum, vanadium, titanium, antimony, iron, and certain alloys thereof as well as certain ceramics formed of quartz, alumina, zirconia, aluminum-doped zinc oxide or indium tin oxide.

In certain embodiments, it can be particularly useful for the thermal shock resistant substrate to be formed from a single crystal metal. As can be appreciated, single crystal metals are formed with a continuous crystal lattice free of defects and grain boundaries that can lead to premature failure. However, in certain embodiments, the thermal shock resistant substrate can alternatively be formed of polycrystalline or amorphous structures.

### Applications

In certain embodiments, the glassy carbon coatings described herein can be particularly suitable for inclusion in batteries where the glassy carbon coatings can provide durable coatings that resist chemical corrosion, thermal expansion and contraction, improves wettability of alkali anodes, and prevents undesirable chemical reactions and interdiffusion as a diffusion barrier from taking place. In such embodiments, the glassy carbon coatings can be provided on numerous substrates inside of the battery including on the current collector, electrodes, or to bond such substrates to adjacent substrates. For example, the glassy carbon coatings can provide for improved wettability of the current collectors to an alkali anode due to the smooth coating, opportunity for the alkali ion to intercalate into the glassy carbon, provide for complete electrical conductivity by coating potentially insulating impurities or voids in the current collector, and resist chemical attack from the acidic or caustic solutions.

In certain embodiments, the glassy carbon coating can be included in lithium-ion, sodium-ion and potassium-ion batteries, and especially such batteries that use a solid electrolyte both with and without an anolyte. The glassy carbon coating is especially useful for ‘anodeless’ designs where the solid electrolyte is placed, deposited and/or grown on top of the glassy carbon and the alkali anode will be electrodeposited between the glassy carbon and solid electrolyte because alkali metals readily wet carbon which will aid in preventing dendrite formation during battery operation.

In certain embodiments, the glassy carbon coatings can be included in metal air batteries. As can be appreciated, metal air batteries include multiple substrates some of which require smooth surfaces with high wettability, high electrical conductivity, and resistance to chemical attack. Such substrates include the current collectors and the electrodes. An exemplary metal air battery can be a sodium air battery including sodium hydroxide as the aqueous electrolyte and a ceramic solid electrolyte formed on top of the negative current collector. Additional examples of exemplary metal air batteries are disclosed in U.S. patent App. Pub. No. 2023/0068006 A1, hereby incorporated by reference herein.

### Exemplary Metal Air Battery

Exemplary metal air batteries can include aqueous metal-air batteries including a metal anode, at least one air cathode, a solid electrolyte, and an aqueous electrolyte layer (sometimes called a catholyte layer). In certain embodiments, the metal air battery can be a sodium air battery including sodium hydroxide as the aqueous electrolyte.

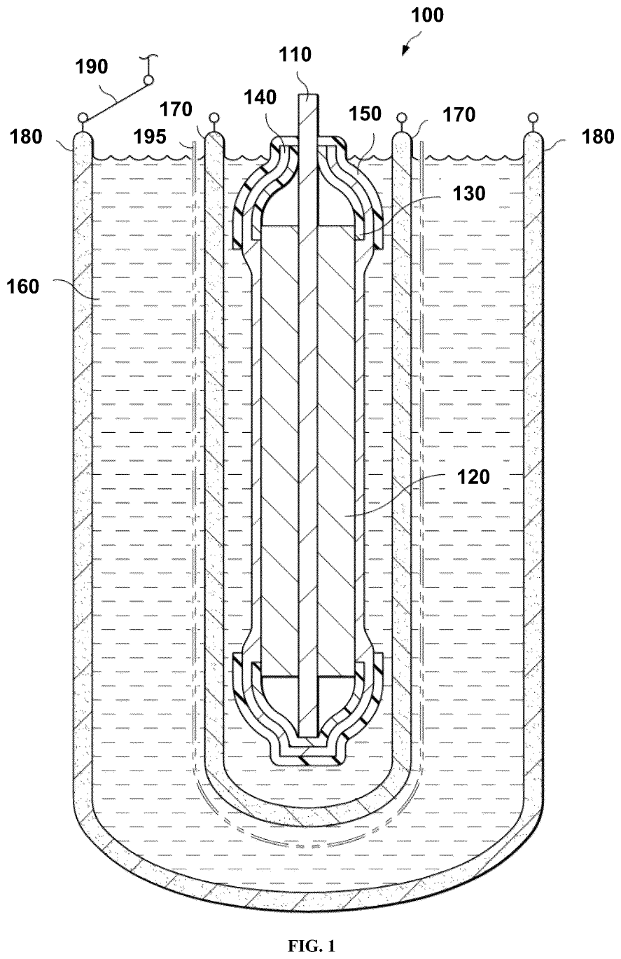

A side view of an exemplary metal-air battery is depicted in FIG. 1. As depicted in FIG. 1, the battery 100 can include a current collector 110, an anode 120 surrounding the current collector 110, a solid electrolyte 140 bonded to the anode 120, an aqueous electrolyte 160 in fluid contact and surrounding the solid electrolyte 140, an oxygen evolution electrode 170 in the aqueous electrolyte 160, and an oxygen reduction electrode 180 acting also as an outer wall for the battery 100.

In certain such exemplary embodiments, the metal anode can be formed in-situ by plating onto the current collector during charging of the metal-air battery. In certain embodiments, the air cathode can include separate oxygen reduction and oxygen evolution electrodes for the oxygen reduction reactions (“ORR”) and oxygen evolution reactions (“OER”) enabling optimization of the ORR and OER reactions. The surface area of the air cathode(s) can be expanded by use of a blowing agent in combination with an electrically conductive catalyst and a polymer stable against the catholyte solution. Use of the blowing agent can allow the pores within the electrode to quickly expand from the release of gases from the blowing agent during manufacture and can allow for more efficient reduction and evolution of oxygen from more three phase (gas-liquid-solid) interfaces.

The solid electrolyte can be an ionically conductive layer or film that is impermeable to water and oxygen which separates the anode and cathode while allowing for ionic charge carriers to pass. In certain embodiments, the solid electrolyte can be directly attached to a conductive substrate which provides inherently perfect, or nearly perfect, metal-solid electrolyte interface contact or metal-glassy carbon-solid electrolyte interface contact and additional mechanical strength and durability to the solid electrolytes. The solid electrolyte can be formed of any suitable material that can allow ions to transit the separator while being impenetrable to water and oxygen. In certain embodiments, such materials can be a ceramic material while in other embodiments, such materials can alternatively, or additionally, be polymeric materials. Examples of suitable ceramic materials include sodium beta-alumina, potassium beta-alumina, lithium beta-alumina, Nasicon-type, Lisicon-type, garnet-type, perovskite-type, NaPON and LiPON-type, Li₃N-type, Na₃N-type, argyrodite-type, anti-perovskite type ceramics, phosphate ceramics (Li/Na/K/Rb/Cs/Fr)₃PO₄, and borate ceramics (Li/Na/K/Rb/Cs/Fr)₃BO₃.

In certain embodiments, the metal-air battery can include a thin film protective coating for the solid electrolyte surfaces. The thin film protective coating can be attached to the solid electrolyte and can allow conduction of ions while preventing and/or minimizing the transfer of hydroxide to the surface of the solid electrolyte. The thin film protective coating can be formed by attaching ligands to the surface of the solid electrolyte. Suitable ligands can include any ligands that can repel hydroxide while allowing transfer of ionic species. For example, suitable ligands can include ether, ketone, ester, carboxylic acid, aldehyde, alkyl halide, carbonate, peroxide, alcohols, SO3—, OSO3—, carboxamide, amidine, amine, ketimine, aldimine, imide, azide, azo, cyanate, isocyanate, nitrate, nitrile, isonitrile, nitrosooxy, nitro, nitroso, oxime, pyridyl, carbamate, thiol, sulfide, disulfide, sulfinyl, sulfonyl, sulfino, sulfo, thiocyanate, Isothiocyanate, carbonothioyl, carbothioic S-acid, carbothioic O-acid, thiolester, thionoester, carbodithioic acid, carbodithio, phosphino, phosphono, and phosphate ligands. Suitable ligands can be further functionalized and can be of any length. For example, suitable ligands can be about 1 carbon to about 5000 carbons long or even longer. Alternatively, the thin film protective coating can be a cation exchange resin.

Generally, the glassy carbon coatings described herein can be used on each substrate in the battery where a durable, chemically resistant, diffusion barrier coating with high alkali metal wettability is useful. For example, the glassy carbon coating can be used to attach, or form the surface of, the current conductor. As can be appreciated, a current collector having a smooth surface formed of the glassy carbon coating layer described herein can allow for more uniform electroplating of the anode having fewer dendrites, longer lifespans, and greater effective battery charge. In certain embodiments, the glassy carbon coating described herein can include the thermal shock resistant substrate to mitigate damage caused by thermal heating and cooling during manufacture.

In certain embodiments, the exemplary metal air battery disclosed herein can include a coating formed of a thermal shock resistant substrate or other metal and graphite or graphene instead of the glassy carbon coating.

As can be appreciated, the metal air battery described herein is an exemplary metal air battery and the glassy carbon coatings described herein can be used in variations of such metal air battery. In particular, the glassy carbon coatings can be useful in any battery requiring durable, chemically resistant, diffusion barrier coatings with high alkali metal wettability.

### EXAMPLES

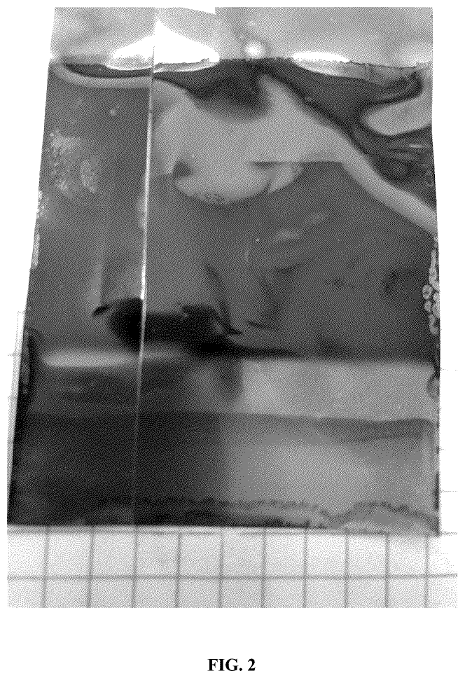

FIG. 2 depicts a photograph showing a sample of glassy carbon coating formed by carbonizing a single layer phenolic resin made by dip coating and heated in a nitrogen atmosphere via a xenon flash lamp with 24.5 J/cm² energy input although more conventional heating methods work as well. The glassy carbon coating has a glass-like appearance, an extremely smooth surface, and is flexible and well adhered. Multiple thinner layers or thicker individual layers can be deposited and carbonized in inert atmosphere as well.

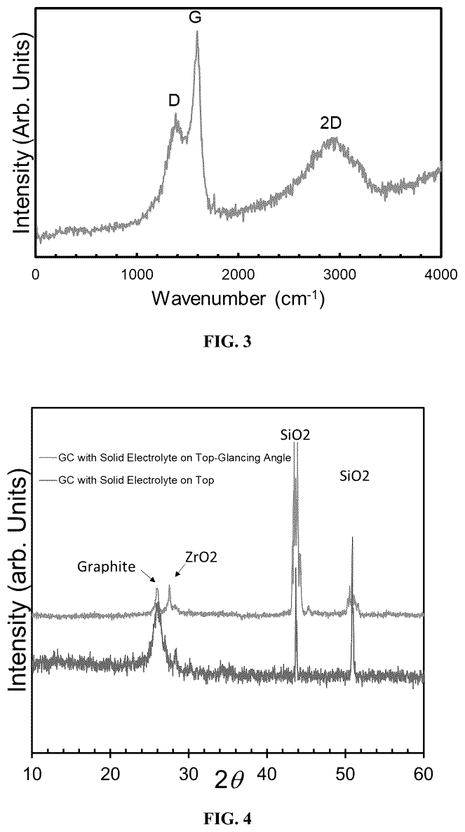

The sample depicted in FIG. 2 was evaluated using raman spectroscopy and XRD spectroscopy. The Raman spectra is depicted in FIG. 3 while the XRD spectra is depicted in FIG. 4.

FIG. 3 indicates that glassy carbon was formed as indicated by the presence of the wide D band characteristic of disordered carbon. The G and 2D Raman bands in FIG. 3 together with the small graphite peaks seen in the x-ray diffraction analysis of FIG. 4 indicate nanosized graphite domains that exist and confer electrical conductivity to the sample.

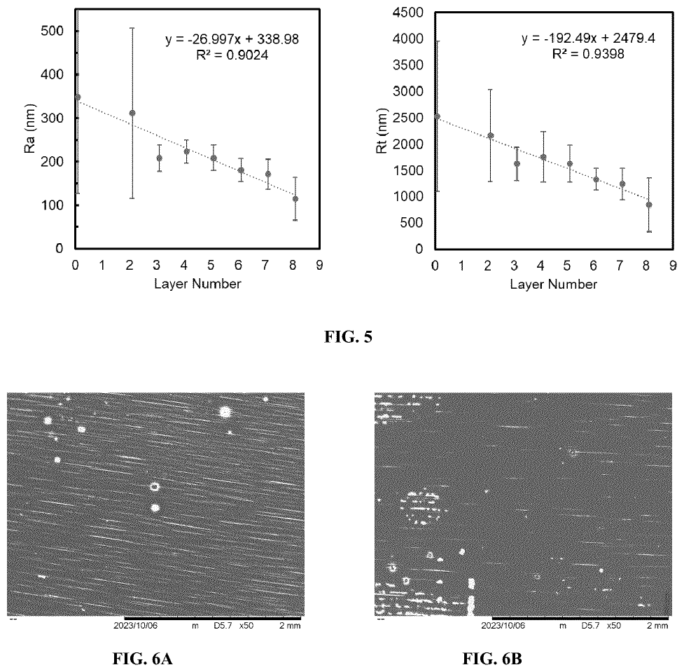

An additional glassy carbon coating including 2 through 8 layers of glassy carbon formed on stainless steel was produced. The additional glassy carbon coating was evaluated for surface roughness using a Bruker DektakXT Stylus Profilometer using a scan length of 2 mm. Each measurement was performed 20 times on each layer. The Rₐ (arithmetic mean roughness) and Rₜ (maximum peak to valley height) of each layer of the glassy carbon coating is depicted in FIG. 5.

As depicted in FIG. 5, each layer of the glassy carbon reduced the surface roughness of a substrate. As the number of layers of glassy carbon is increased, the surface roughness is expected to further decrease.

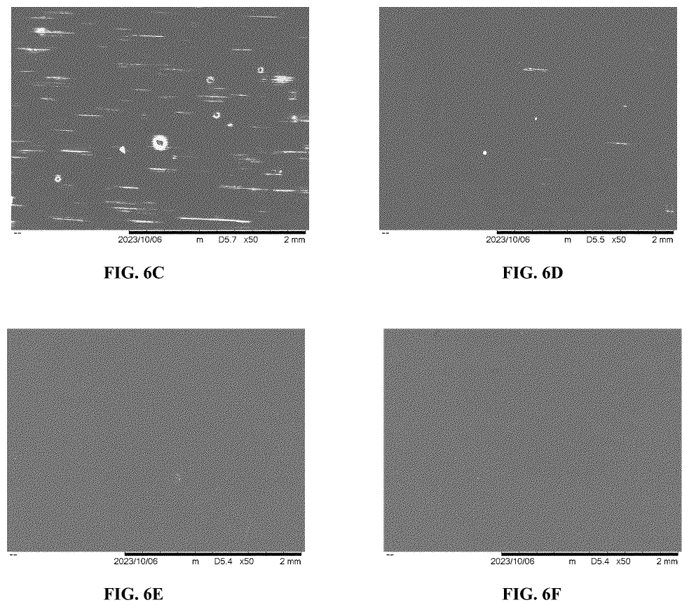

FIGS. 6A to 6F depict scanning electron microscope images of the additional glassy carbon coating. Specifically, FIG. 6A depicts a scan of the first layer; FIG. 6B depicts a scan of the second layer, FIG. 6C depicts a scan of the fourth layer, FIG. 6D depicts a scan of the fifth FIG. 6E depicts a scan of the 7^{th} layer, and FIG. 6F depicts a scan of the 8^{th} layer.

As depicted in the SEM images of FIG. 6, the inherent roughness of the stainless steel substrate (visible as straight lines) disappears with each successive glassy carbon coating layer.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

It should be understood that certain aspects, features, structures, or characteristics of the various embodiments can be interchanged in whole or in part. Reference to certain embodiments mean that a particular aspect, feature, structure, or characteristic described in connection with certain embodiments can be included in at least one embodiment and may be interchanged with certain other embodiments. The appearances of the phrase “in certain embodiments” in various places in specification are not necessarily all referring to the same embodiment, nor are certain embodiments necessarily mutually exclusive of other certain embodiments. It should also be understood that the steps of the methods set forth herein are not necessarily required to be performed in the orders described, and the order of the steps of such methods should be understood to be merely exemplary. Likewise, additional steps can be included in such methods, and certain steps may be omitted or combined, in methods consistent with certain embodiments.

What is claimed is:

1. An article comprising:
one or more substrates; and
a carbon coating layer on one or more of the one or more substrates, the carbon coating layer comprising one or more of glassy carbon, graphite, or graphene.

2. The article of claim 1, wherein the carbon coating layer is a glassy carbon coating layer.

3. The article of claim 1, wherein the carbon coating layer comprises a single layer.

4. The article of claim 1, wherein the carbon coating layer comprises about 100 or fewer layers.

5. The article of claim 1, wherein the carbon coating layer reduces the surface roughness of the one or more substrates.

6. The article of claim 1, wherein the substrate is a plastic, ceramic, or metal.

7. The article of claim 1, wherein the carbon coating layer further comprises a thermal shock resistant layer.

8. The article of claim 7, wherein the thermal shock resistant layer comprises a single crystal metal or an amorphous metal.

9. The article of claim 8, wherein the single crystal metal or amorphous metal comprises copper, zirconium, hafnium, chromium, germanium, tantalum, vanadium, titanium, antimony, iron, or an alloy thereof.

10. The article of claim 7, wherein the thermal shock resistant substrate comprises a ceramic material, the ceramic material comprising quartz, alumina, zirconia, an indium tin oxide, aluminum-doped zinc oxide or any conductive oxide.

11. The article of claim 7, wherein the thermal shock resistant layer exhibits a coefficient of thermal expansion of about 0 to about 17 mm/mK.

12. The article of claim 7, wherein the thermal shock resistant layer exhibits a coefficient of thermal expansion of about 0 to about 7 mm/mK.

13. The article of claim 1, wherein the article further comprises an interlayer material between the substrate and the carbon coating layer, the interlayer material comprising a carbide.

14. The article of claim 1 is a battery, medical device, medical implant, sensor probe, cookware, industrial tank or pipe, or a chemical storage container.

15. The article of claim 14 is a lithium ion battery, a sodium ion battery, a lithium air battery, a sodium air battery or a battery comprising a lithium, sodium, potassium, cesium, rubidium or alloy thereof metal anode.

16. The article of claim 15, wherein the glassy carbon coating layers are present between current collector and a solid electrolyte.

17. The article of claim 16, wherein the carbon coating completely coats the substrate surface and is itself coated by the solid electrolyte.

18. A method of forming a glassy carbon coating layer comprising the steps of:
depositing a phenolic resin or other non-graphitizable polymer on a substrate;
allowing surface tension to flatten the phenolic resin or other non-graphitizable polymer; and
carbonizing the phenolic resin or other non-graphitizable polymer to a glassy carbon to form the glassy carbon coating layer.

19. The method of claim 18, further comprising the step of heating the phenolic resin or other non-graphitizable polymer to set the phenolic resin or other non-graphitizable polymer prior to carbonization.

20. The method of claim 19, further comprising the step of:
depositing a metal or ceramic layer before depositing the phenolic resin or other non-graphitizable polymer or depositing a metal or ceramic layer over the glassy carbon coating layer.
